(19) United States
(12) Patent Application Publication
(10) Pub. No.: US 2026/0327961 A1
(43) Pub. Date: Oct. 22, 2026

(54) AUTOMATIC FAUCET WITH AI-DRIVEN GESTURE-BASED CONTROL

(71) Applicant: AS America, Inc., Piscataway, NJ (US)

(72) Inventors: Xiaojing YE, Edison, NJ (US); David D. ESPIRITO SANTO, Colonia, NJ (US)

(73) Assignee: AS America, Inc., Piscataway, NJ (US)

(21) Appl. No.: 19/491,480

(22) PCT Filed: Jun. 5, 2024
(86) PCT No.: PCT/US2024/032609

§ 371 Date: Dec. 9, 2025

Related U.S. Application Data
(60) Provisional application No. 63/472,480, filed on Jun. 12, 2023.

(51) Int. Cl. E03C 1/05; G06F 3/01; G06V 40/20

(52) U.S. Cl. CPC E03C 1/057; G06F 3/017; G06V 40/28

(57) ABSTRACT

Provided are faucet assemblies having gesture recognition driven by AI camera sensors. The faucet assemblies provided herein can include one or more camera sensors configured to detect image data of users of the faucet assemblies, one or more processors configured to perform AI-based gesture recognition based on the detected image data, and one or more valves to control fluid flow through the faucet assemblies based on the recognized gestures. In some embodiments, the one or more processors may be configured to recognize user hand gestures, such as an open hand or a closed fist, in the detected image data.

### CROSS-REFERENCE TO RELATED APPLICATIONS

This application claims the benefit of U.S. Provisional Application No. 63/472,480, titled “AUTOMATIC FAUCET WITH AI-DRIVEN GESTURE-BASED CONTROL” and filed on Jun. 12, 2023, the entire content of which is incorporated herein by reference for all purposes.

### FIELD

The present invention relates generally to faucet assemblies, and in particular, to faucet assemblies having AI-based gesture recognition driven by camera sensors.

### BACKGROUND

Conventional faucets are designed to provide a continuous stream of water when turned ON by a user and to stop the stream of water when turned OFF by a user. Conventional manual faucets require the user to mechanically turn water flow ON or OFF by operating a user interface through physical touch. Conventional automatic faucets require the user to electronically turn water flow ON or OFF by activating or deactivating a proximity sensor on the faucet assembly.

### SUMMARY

As described above, conventional faucets require users to make physical contact with or to be in proximity to the faucet in order to turn water flow ON or OFF. However, in some situations, the user may wish to operate the faucet from a distance without making physical contact with or being in proximity to the faucet. For example, while operating at a workstation a distance away from the faucet, a user may wish to turn water flow ON in order to fill a basin underneath the faucet without leaving the workstation. This operation of a faucet from such a distance is not possible with existing conventional faucets. Thus, there exists a need for faucet assemblies that provide a mechanism for faucet users to operate a faucet from a distance.

Furthermore, known touchless faucet control systems are limited to functionality provided by distance sensors (e.g., IR-based distance sensors), which provides low resolution information to the faucet and limits the granularity, precision, and control that the user may execute using touchless control. Thus, there exists a need for touchless faucet assemblies that provide improved granularity, control, and precision to users of the faucet.

Provided herein are faucet assemblies that meet one or more of the above-identified needs.

Provided are faucet assemblies having gesture recognition driven by artificial intelligence that processes signals received from one or more camera sensors. The faucet assemblies provided herein can include one or more camera sensors configured to detect image data of users of the faucet assemblies, for example by capturing gestures (e.g., hand gestures) performed by a user. One or more processors of a faucet assembly may be configured to perform AI-based gesture recognition based on the detected image data, and to responsively automatically operate one or more valves to control fluid flow through the faucet assembly based on one or more recognized gestures. In some embodiments, the one or more processors may be configured to recognize user hand gestures, such as an open hand or a closed fist, in the detected image data.

Accordingly, unlike the conventional faucets described above, the faucet assemblies disclosed herein include AI-based gesture recognition that leverages data received from camera sensors. By substituting (or augmenting) the proximity sensor of the conventional automatic faucet described above with a camera sensor, the faucet assemblies described herein gain the capability to recognize gestures from a user's hand or hands, including recognizing a large number of different gestures. Consequently, user gestures can be used to operate the faucet assemblies described herein from a distance, and a large number of different faucet functionalities can be mapped to a large number of different hand gestures that can be quickly and effectively differentiated from one another using AI-enabled camera sensors. For example, in some embodiments, when the AI-based gesture recognition processors recognize that a user's hand or hands are open, with the palm or palms facing the camera sensor, water flow may be turned ON. In some embodiments, when the AI-based gesture recognition processors recognize that a user's hand or hands are closed into a fist, water flow may be turned OFF. Accordingly, AI-based gesture recognition driven by camera sensors acts as a mechanism for faucet users to operate the faucet from a distance, affording the user an increased level of control in precision in the manner in which the faucet may be touchlessly controlled.

According to some embodiments, provided herein is a faucet assembly comprising: a faucet body comprising: a fluid inlet configured to receive fluid from a fluid source; a first valve movable between an ON configuration and an OFF configuration to control flow of the received fluid along a fluid flow path; a spray head comprising one or more fluid outlets fluidly connected to the fluid flow path and configured to dispense fluid out of the faucet body; and a camera sensor configured to detect image data of a user of the faucet assembly; and one or more processors electronically connected to the camera sensor and to the valve, the one or more processors configured to: perform AI-based gesture recognition based on the detected image data to recognize a gesture of the user, and transmit a signal to the first valve, based on the recognized gesture, to cause the first valve to move from the ON configuration to the OFF configuration or from the OFF configuration to the ON configuration.

In some embodiments, the first valve is a solenoid valve.

In some embodiments, moving the first valve from the ON configuration to the OFF configuration allows the spray head of the faucet body to stop dispensing fluid.

In some embodiments, moving the first valve from the OFF configuration to the ON configuration allows the spray head of the faucet body to start dispensing fluid.

In some embodiments, the first valve may be configured to automatically return to an OFF configuration once a predetermined amount of time has passed, and wherein no AI-based gesture recognition is necessary for the first valve to return to the OFF configuration.

In some embodiments, the first valve may be configured to automatically return to an OFF configuration once a predetermined amount of fluid has been dispensed, and wherein no AI-based gesture recognition is necessary for the first valve to return to the OFF configuration.

In some embodiments, in the ON configuration, the first valve is fully open or partially open.

In some embodiments, the faucet body further comprises a handle.

In some embodiments, the handle is a lever handle.

In some embodiments, the handle is configured to control the first valve.

In some embodiments, the handle is configured to control a second valve movable between an ON configuration and an OFF configuration.

In some embodiments, the second valve is a disk valve.

In some embodiments, the second valve is fluidly connected to the fluid flow path and positioned upstream or downstream of the first valve.

In some embodiments, the second valve is positioned in series with the first valve.

In some embodiments, the faucet assembly is configured to operate by moving the handle, to operate by transmitting the signal to the first valve based on the recognized gesture, or to operate by both.

In some embodiments, the handle is moved to a position for dispensing fluid out of the faucet body by the spray head at a desired flow rate and a desired temperature, and based on the image data of the user, the first valve moves between the ON configuration and the OFF configuration to control whether fluid is being dispensed out of the faucet body by the spray head.

In some embodiments, handle control overrides gesture control, such that moving the handle overrides controlling the first valve based on the signal transmitted based on the recognized gesture.

In some embodiments, gesture control overrides handle control, such that transmitting the signal to the first valve based on the recognized gesture overrides controlling the first valve based on moving the handle.

In some embodiments, the faucet assembly further comprises a proximity sensor configured to detect a user in proximity to the sensor, wherein the one or more processors transmit a signal to the first valve, based on the presence of the user or an object near the faucet assembly, to move the first valve from the ON configuration to the OFF configuration or from the OFF configuration to the ON configuration.

In some embodiments, the AI-based gesture recognition capabilities of the one or more processors are inactive until the presence of the user or the object near the faucet assembly is detected by the proximity sensor.

In some embodiments, the AI-based gesture recognition capabilities of the one or more processors are deactivated when the presence of the user or the object near the faucet assembly is detected by the proximity sensor.

In some embodiments, the faucet body is a kitchen faucet.

In some embodiments, the faucet body further comprises an outer housing comprising: a spout configured to hold the fluid flow path of the faucet body; and an escutcheon plate configured to be mounted on a top surface of a sink deck; wherein one end of the spout is configured to connect to the spray head of the faucet body and another end of the spout is configured to connect to the escutcheon plate.

In some embodiments, the camera sensor is fixed to a sensor holder mounted within the spout and positioned proximate to an opening in the front of the spout.

In some embodiments, the AI-based gesture recognition capabilities of the one or more processors are configured to associate different gestures with different actions, including but not limited to: raising or lowering a fluid temperature, changing between a plurality of spray patterns, or disabling one or more capabilities of the faucet.

In some embodiments, the gesture of a user is an open hand or a closed fist.

In some embodiments, upon recognizing the gesture of the user as an open hand, the one or more processors transmit a signal to the valve to cause the valve to move from the OFF configuration to the ON configuration.

In some embodiments, upon recognizing the gesture of the user as a closed fist, the one or more processors transmit a signal to the valve to cause the valve to move from the ON configuration to the OFF configuration.

In some embodiments, the faucet assembly further comprises a battery electronically connected to the camera sensor and to the one or more processors.

In some embodiments, the one or more processors include a PCB.

In some embodiments, the faucet body further comprises a toggle switch configured to disable and enable the camera sensor detecting the image data of the user.

In some embodiments, the one or more processors are electronically connected to a manual temperature control, and a temperature of the fluid is determined according to a setting of the manual temperature control.

In some embodiments, the manual temperature control comprises a knob or dial.

### BRIEF DESCRIPTION OF THE DRAWINGS

The invention will now be described, by way of example only, with reference to the accompanying drawings, in which:

FIG. 1A shows an external view of a faucet assembly with AI-based gesture recognition capabilities, according to some embodiments;

FIG. 1B shows an internal view of a faucet assembly with AI-based gesture recognition capabilities, according to some embodiments;

FIG. 2 shows a conceptual diagram of a faucet assembly wherein an AI gesture recognition assembly controls a first valve and a handle controls a second valve along the same fluid flow path, according to some embodiments; and

FIG. 3 shows a conceptual diagram of a faucet assembly wherein an AI gesture recognition assembly and a handle control the same valve, according to some embodiments.

FIG. 4 shows a conceptual diagram of a faucet assembly wherein an AI gesture recognition assembly controls a valve, according to some embodiments.

### DETAILED DESCRIPTION

Provided are faucet assemblies having AI-based gesture recognition capabilities leveraging one or more camera sensors. The faucet assemblies provided herein can include one or more camera sensors configured to detect image data of users of the faucet assemblies, one or more processors configured to perform AI-based gesture recognition based on the detected image data, and one or more valves to control fluid flow through the faucet assemblies based on the recognized gestures. In some embodiments, the one or more processors may be configured to recognize user hand gestures, such as an open hand or a closed fist, in the detected image data, and to automatically control the one or more valves in accordance with one or more of the detected gestures.

As described above, conventional faucets require a user to make physical contact with or to be in proximity to the faucet in order to turn water flow ON or OFF. However, in some situations, the user may wish to operate the faucet from a distance without making physical contact with or being in proximity to the faucet. For example, while operating at a workstation a distance away from the faucet, a user may wish to turn water flow ON in order to fill a basin underneath the faucet without leaving the workstation. This operation of a faucet from such a distance is not possible with existing conventional faucets. Thus, there exists a need for a faucet assembly which provides a mechanism for faucet users to operate a faucet from a distance.

Conversely, the faucet assemblies disclosed herein include AI-based gesture recognition leveraging data from one or more camera sensors. By substituting or augmenting proximity sensor of conventional automatic touchless faucets with one or more AI-enabled camera sensors, the faucet assemblies described herein gain the capability to recognize gestures from a user's hand or hands, including using AI to recognize and differentiate a large number of different hand gestures. User gestures can thus be used to operate a large number of faucet functions from a distance. For example, in some embodiments, when the AI-based gesture recognition processors recognize that a user's hand or hands are open, with the palm or palms facing the camera sensor, water flow may be turned ON. In some embodiments, when the AI-based gesture recognition processors recognize that a user's hand or hands are closed into a fist, water flow may be turned OFF.

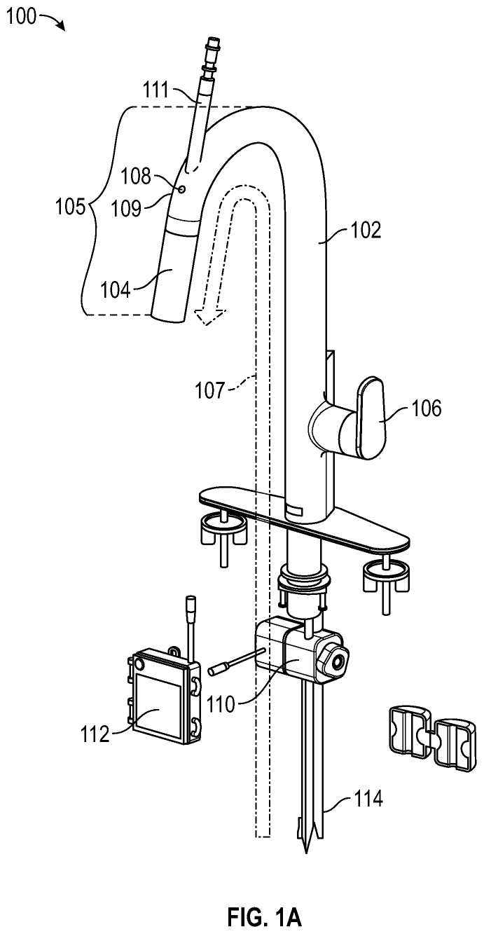

FIG. 1A shows a partially exploded external view of a faucet assembly 100 with gesture recognition capabilities, according to some embodiments. Namely, FIG. 1A shows a faucet assembly 100 comprising a faucet body 102, a spray head 104, a handle 106, a fluid flow path 107, a camera sensor 108, a camera sensor opening 109, a first valve 110, a pull-down hose 111, a battery holder 112, and inlet conduits 114. The first valve 110 may be operated via gesture control, wherein image data of a user's hand gestures may be captured by the camera sensor 108. One or more processors communicatively coupled to camera sensor 108 may process the captured image data using one or more AI-based data processing operations to detect and recognize one or more of the gestures. Based on the recognized gesture(s), the one or more processors may control operation of the first valve 110, for example by causing the valve to move between an ON configuration and an OFF configuration. As described herein, moving between an ON configuration and an OFF configuration means to move from ON to OFF or from OFF to ON, and all stages in between (e.g., the first valve 110 may be fully open, partially open, or closed).

In some embodiments, the fluid flow path 107 may be partially or fully enclosed within the faucet body 102 and may run from a fluid source to the spray head 104. A portion of the fluid flow path 107 may be a pull-down hose 111, affording pull-down functionality to spray head 104. The inlet conduits 114 and the first valve 110 may form a part of fluid flow path 107. The inlet conduits 114 may be fluidically connected to and positioned upstream of the first valve 110, as well as fluidically connected to and positioned downstream of the fluid source. Furthermore, the first valve 110 may be fluidically connected to and positioned upstream of the spray head 104, such that fluid from the inlet conduits 114 must pass through the first valve 110 in order to reach the spray head 104. The handle 106 may be positioned proximate to the fluid flow path 107. The camera sensor opening 109 may be positioned on a front surface of the faucet body 102 that faces the user during operation. The camera sensor 108 may be mounted inside of the faucet body 102 and positioned proximate to the camera sensor opening 109 such that it can detect a user's hand gestures without obstruction by the faucet body 102. The battery holder 112 may be configured to hold a battery that is electronically connected to (e.g., supplies power to) the camera sensor 108.

In some embodiments, the faucet body 102 includes a hollow, outer housing to contain various components of the faucet assembly 100. The outer housing may comprise a spout 105 configured to contain and direct the fluid flow path 107, which may run parallel to and along the inside of the spout 105. Additionally, the outer housing may comprise an escutcheon plate configured to fasten onto a top surface of the sink deck, as well as a shank configured to fasten the spout 105 and the escutcheon plate together. One end of the spout 105 may be physically connected to the spray head 104; the other end of the spout 105 may be physically connected to the escutcheon plate. Faucet body 102 may include camera sensor opening 109, a hole in the outer housing, which may be positioned on a front surface of the faucet body 102, e.g., a surface which faces the user during operation of the faucet. The camera sensor opening 109 may be any shape or size, as long as the hole is large enough to expose a camera sensor 108. In some embodiments, a transparent, waterproof panel may cover the camera sensor opening 109 so as to prevent dispensed fluid from entering the faucet body 102 and to protect the internal components from unwanted fluid exposure. In some embodiments, the faucet body 102 may be physically connected to the handle 106 via one or more screws, hinges, or other coupling mechanisms. In some embodiments, the faucet body 102 may be physically and removably connected to the spray head 104 such that the spray head 104 may be detached from the one end of the spout 105, pulled a distance away from the faucet body 102, and reattached to the spout 105, all while maintaining fluid flow throughout the fluid flow path 107. In such embodiments, the fluid flow path 107 may comprise a flexible, retractable conduit that is extendable beyond the one end of the spout 105, such as pull-down hose 111, affording pull-down functionality to spray head 104. In some embodiments, the faucet body 102 may be a kitchen faucet. In some embodiments, the faucet body 102 may comprise a toggle, switch, knob, or other adjustable feature that can disable or enable the image detection capabilities of camera sensor 108. This may be useful for preserving user privacy, child-proofing faucet operations, and/or providing flexibility to users in the manner in which the faucet can be controlled.

In some embodiments, the spray head 104 includes a nozzle at one end of the faucet body 102 that is configured to dispense fluid out of the faucet assembly 100. For example, the spray head 104 may be configured to dispense water into a water receptacle (e.g., a kitchen sink, a bathroom sink, or a bathtub). In some embodiments, spray head 104 may comprise one or more controls configured to control a spray pattern of water dispensed into the water receptacle. In some embodiments, the spray head 104 may include an aerator and a check valve fluidly connected to the fluid flow path 107, along with one or more buttons, dials, knobs, switches, etc. configured to activate and/or toggle between spray patterns. In some embodiments, the spray head 104 may be fluidly coupled to the fluid flow path 107 such that fluid from the inlet conduits 114 flows through the faucet body 102 along the fluid flow path 107, passing through the first valve 110, before being dispensed by the spray head 104. In some embodiments, the spray head 104 may be retractable. In such embodiments, the spray head 104 may be removably connected to the faucet body 102 via the pull-down hose 111 such that the spray head 104 may be detached from the one end of the spout 105, pulled a distance away from the faucet body 102, and reattached to the spout 105, all while maintaining fluid flow throughout the fluid flow path 107. In such embodiments, the fluid flow path 107 may comprise a flexible, retractable conduit that extends beyond the one end of the spout 105, such as the pull-down hose 111, in order to remain attached to the spray head 104.

In some embodiments, the handle 106 includes a handle for operating the faucet assembly 100. In some embodiments, the handle 106 may include a lever handle compatible with a kitchen faucet. In such embodiments, the handle 106 may include a single-lever pull-down handle. The handle 106 may be physically connected to the faucet body 102 via one or more screws, hinges, or other coupling mechanisms. Furthermore, the handle 106 may be physically and/or electronically connected to components contained inside the faucet body 102, which may include a second valve and a manifold, as described in FIG. 1B. In such embodiments, moving the handle 106 may adjust the flow of fluid through the second valve and the manifold, thereby adjusting the temperature and/or the flow rate of fluid through the fluid flow path 107. In some embodiments, as the handle 106 is moved from side to side, the ratio of hot fluid to cold fluid in the fluid flow path 107 may be adjusted, thereby adjusting the temperature of the fluid. In some embodiments, as the handle 106 is angled up or down, the movement may fully open, partially open, or close the second valve, thereby adjusting the flow rate of fluid through the fluid flow path 107. The faucet assembly 100 may be turned ON and OFF by angling the handle 106 up from its original position and back down, respectively. When the side-to-side and up-or-down movement is performed in unison, fluid at the corresponding temperature and flow rate will flow through the fluid flow path 107. The fluid can then flow through the other fluidly connected components along the fluid flow path 107 before being dispensed by the spray head 104.

In some embodiments, the fluid flow path 107 comprises one or more hoses, conduits, pipes, tubes, and/or adapters that direct and carry water from the direction of a fluid source toward the direction of the spray head 104. The fluid flow path 107 may be rigid, flexible, or a combination of the two in different areas. In such embodiments, the fluid flow path 107 may comprise a flexible, retractable conduit that can remain coupled to the spray head 104 when the spray head 104 is pulled away from the faucet body 102. In some embodiments, the fluid flow path 107 may be fluidly connected to the inlet conduits 114, the first valve 110, and the spray head 104. Alternatively, in some embodiments, the fluid flow path 107 may be fluidly connected directly to the fluid source, bypassing the inlet conduits 114 entirely. In some embodiments, the fluid flow path 107 may include a quick-connect mixing pull-down hose 111 with a threaded fitting located at the end connected to spray head 104, along with a male barbed fitting located at another end connected to the first valve 110. In some embodiments, fluid from the inlet conduits 114 may flow through the faucet body 102 along the fluid flow path 107, passing through the first valve 110, before being dispensed by the spray head 104. In some embodiments, the fluid flow path 107 may have a circular cross-sectional shape. The material of the fluid flow path 107 may be, for example, and without limitations, cross-linked polyethylene (PEX) or other plastics, rubber, metal, etc.

In some embodiments, the camera sensor 108 includes a sensor that captures or detects image data of a user of the faucet assembly 100. The image data detected by camera sensor 108 may include the user's hand or hands. In some embodiments, the camera sensor 108 may capture image data in a visible light wavelength. In some embodiments, the camera sensor 108 may capture image data in other light wavelengths, such as infrared light, to operate under a range of visibility conditions. The camera sensor 108 may be electronically connected to a power supply, processors, other sensors, motors, wires, or any other electronic components of the faucet assembly 100. In such embodiments, the camera sensor 108 may include one or more wires for creating these electronic connections. In some embodiments, the electronic connections may be wireless. One or more lenses may be positioned proximate to the camera sensor 108. In some embodiments, the camera sensor 108 may be positioned proximate to the camera sensor opening 109 on a front surface of the faucet body 102, and partially or fully inside of the faucet body 102. In such embodiments, the camera sensor 108 may be partially or fully exposed such that it is capable of detecting image data of the user during operation of the faucet assembly 100. In some embodiments, a transparent, waterproof panel may cover the camera sensor opening 109 so as to prevent dispensed fluid from entering the faucet body 102 and to protect the camera sensor 108 from unwanted fluid exposure. The camera sensor 108 may be fixed to a sensor holder mounted within the spout 105 of faucet body 102.

In some embodiments, the first valve 110 includes a valve movable between an ON configuration and an OFF configuration to control fluid flow along the fluid flow path 107. The first valve 110 may be fluidly connected to any other components along the fluid flow path 107. In some embodiments, the first valve 110 may be positioned upstream of a second valve along the fluid flow path 107. Alternatively, in some embodiments, the first valve 110 may be positioned downstream of a second valve along the fluid flow path 107. In some embodiments, the first valve 110 may be an electromechanical valve, such as a solenoid valve. The first valve 110 may be electronically connected to the camera sensor 108, other sensors, a power supply, processors, motors, wires, or any other electronic components of the faucet assembly 100. In some embodiments, the electronic connections may be wireless. In some embodiments, the first valve 110 may be configured to receive signals from one or more processors configured to perform AI-based gesture recognition on image data from the camera sensor 108. These signals may cause the first valve 110 to move from the ON configuration to the OFF configuration, and vice versa. Moving the first valve 110 from the ON configuration to the OFF configuration may close the internal waterway of the first valve 110, thereby causing the spray head 104 to stop dispensing fluid. Moving the first valve 110 from the OFF configuration to the ON configuration may fully open or partially open the internal waterway of the first valve 110, thereby allowing the spray head 104 to start dispensing fluid (assuming that any other necessary valves along flow path 107 are also open). The spray head 104 may dispense a greater volume of fluid when the internal waterway of the first valve 110 is fully open than when it is partially open. Thus, the first valve 110 can control a fluid flow volume, or fluid flow rate, of the faucet assembly 100. In some embodiments, the fluid flow volume of the faucet assembly 100 may be set by the user such that, in the ON configuration, fluid will be dispensed at a set rate. The first valve 110 may also be configured to control the ratio of hot fluid to cold fluid in the fluid flow path 107. Thus, the first valve 110 can control a fluid temperature of the faucet assembly 100.

In some embodiments, the first valve 110 may be operated via gesture control. In such embodiments, when the one or more processors configured to perform AI-based gesture recognition on image data from the camera sensor 108 detect specific user gestures, said processors may cause the first valve 110 to move between the ON configuration and the OFF configuration in accordance with one or more of the detected gestures. For example, when the user gesture is recognized to be an open hand, presented with the palm facing the camera sensor 108, the processors may transmit a signal to the first valve 110 to cause the first valve 110 to move from the OFF configuration to the ON configuration. When the user gesture is recognized to be a closed fist presented to the camera sensor 108, the processors may transmit a signal to the first valve 110 to cause the first valve 110 to move from the ON configuration to the OFF configuration. Gesture control is described in greater detail in the embodiments at the end of this section.

In some embodiments, the battery holder 112 includes a housing for holding a power supply, such as a battery. The power supply may provide power to the electronic components of the faucet assembly 100. In some embodiments, the power supply held by battery holder 112 may be electronically connected to the camera sensor 108, the first valve 110, and any other wires, valves, processors, motors, or other electronic components of the faucet assembly 100. In such embodiments, the battery holder 112 may include one or more wires for creating these electronic connections. In some embodiments, the electronic connections may be wireless.

In some embodiments, the inlet conduits 114 include one or more hoses, pipes, tubes, or adapters that direct and carry water from the direction of a fluid source toward the direction of the fluid flow path 107. The inlet conduits may be referred to as one or more “fluid inlets.” Inlet conduits 114 may be fluidly connected to a hot fluid source and/or a cold fluid source. In some embodiments, inlet conduits 114 may be fluidly connected to a fluid source on one end and the fluid flow path 107 on another end. In some embodiments, one or more of the inlet conduits 114 may have a circular cross-sectional shape. The material of the inlet conduits 114 may be, for example, and without limitations, cross-linked polyethylene (PEX) or other plastics, rubber, metal, etc. The inlet conduits 114 may be rigid, flexible, or a combination of the two in different areas.

FIG. 1B shows an internal cross-sectional view of a faucet assembly 100 with gesture recognition capabilities, according to some embodiments. Namely, FIG. 1B shows a close-up view of the handle region of faucet assembly 100 comprising a handle 106, a fluid flow path 107, a manifold 116, and a second valve 118. The second valve 118 may be the same second valve referred to above with reference to FIG. 1A. The second valve 118 may be operated via handle control, wherein a user manually turns, lifts, or manipulates the handle 106 in order to instruct the second valve 118 to move between an ON configuration and an OFF configuration. Thus, the faucet assembly 100 may be configured to operate by moving the handle (handle control), to operate by the camera sensor detecting the image data of the user (gesture control), or to operate by both methods of control. For example, both a valve controlled by computer-vision-based gesture recognition and a valve controlled by operation of a handle may need to be simultaneously open in order to enable flow from the faucet. In some embodiments, both the manifold 116 and the second valve 118 may be positioned on a fluid flow path 107 running from a fluid source to a spray head. Furthermore, the manifold 116 may be fluidly connected to and positioned upstream of the second valve 118, such that fluid from the fluid source must pass through the manifold 116 and second valve 118 in order to reach the spray head.

In some embodiments, the handle 106 includes a handle for operating the faucet assembly 100. The handle 106 may be physically and/or electronically connected to components contained inside the faucet body 102, which may include the manifold 116 and the second valve 118. In such embodiments, moving the handle 106 may adjust the flow of fluid through the manifold 116 and the second valve 118, thereby adjusting the temperature and/or the flow rate of fluid through the fluid flow path 107. In some embodiments, as the handle 106 is moved from side to side, the ratio of hot fluid to cold fluid in the fluid flow path 107 may be adjusted, thereby adjusting the temperature of the fluid. In some embodiments, as the handle 106 is angled up or down, the movement may fully open, partially open, or close the second valve 118, thereby adjusting the flow rate of fluid through the fluid flow path 107. The faucet assembly 100 may be turned ON and OFF by angling the handle 100 up from its original position and back down, respectively. When the side-to-side and up-or-down movement is performed in unison, fluid at the corresponding temperature and flow rate will flow through the manifold 116 and the second valve 118 along the fluid flow path 107. In some embodiments, the second valve 118 may be operated via handle control, wherein the user manually turns, lifts, or manipulates the handle 106 in order to instruct the second valve 118 to move between an ON configuration and an OFF configuration. Handle 106 of FIG. 1B can include any features of handle 106 of FIG. 1A, and vice versa.

In some embodiments, the fluid flow path 107 comprises a conduit that directs and carries water from the direction of a fluid source toward the direction of the spray head. In some embodiments, the fluid flow path 107 may be fluidly connected to the manifold 116 and the second valve 118. Fluid flow path 107 of FIG. 1B can include any features of fluid flow path 107 of FIG. 1A, and vice versa.

In some embodiments, the manifold 116 includes a hollow shell through which fluid of different temperatures may mix and flow. The manifold 116 may be fluidly connected to any other components along the fluid flow path 107. Hot and/or cold fluid may enter the manifold 116 from the direction of the fluid source along any conduits of the fluid flow path 107, then mix within the manifold 116 until it reaches a uniform temperature. In some embodiments, the second valve 118 may be positioned upstream of the manifold 116 along the fluid flow path 107. In such embodiments, the second valve 118 may control the ratio of hot to cold fluid that enters the manifold 116, thereby controlling the temperature of the fluid that mixes within the manifold 116. Alternatively, in some embodiments, the second valve 118 may be positioned downstream of the manifold 116 along the fluid flow path 107. In such embodiments, the second valve 118 may control the flow of fluid exiting the manifold 116 in the direction of the spray head.

In some embodiments, the second valve 118 is movable between an ON configuration and an OFF configuration to control fluid flow along the fluid flow path 107. The second valve 118 may be fluidly connected to any other components along the fluid flow path 107. In some embodiments, the second valve 118 may be positioned upstream of a first valve along the fluid flow path 107. Alternatively, in some embodiments, the second valve 118 may be positioned downstream of a first valve along the fluid flow path 107. The second valve 118 may be positioned in series with the first valve. In some embodiments, the second valve 118 may be a disk valve. In some embodiments, the second valve 118 may be an electromechanical valve, such as a solenoid valve. The second valve 118 may be electronically connected to a power supply, valves, sensors, processors, motors, wires, or any other electronic components of the faucet assembly 100. In some embodiments, the electronic connections may be wireless. In some embodiments, the second valve 118 may be configured to be operated by the handle 106 via handle control. Moving the handle 106 may cause the second valve 118 to move from the ON configuration to the OFF configuration, and vice versa. Moving the second valve 118 from the ON configuration to the OFF configuration may close the internal waterway of the second valve 118, thereby causing the spray head to stop dispensing fluid. Moving the second valve 118 from the OFF configuration to the ON configuration may fully open or partially open the internal waterway of the second valve 118, thereby allowing the spray head to start dispensing fluid (assuming all other necessary valves are open). The spray head may dispense a greater volume of fluid when the internal waterway of the second valve 118 is fully open than when it is partially open. Thus, the second valve 118 can control a fluid flow volume, or fluid flow rate, of the faucet assembly 100. In some embodiments, the fluid flow volume of the faucet assembly 100 may be set by the user such that, in the ON configuration, fluid will be dispensed at a set volume. The second valve 118 may also be configured to control the ratio of hot fluid to cold fluid in the fluid flow path 107. Thus, the second valve 118 can control a fluid temperature of the faucet assembly 100.

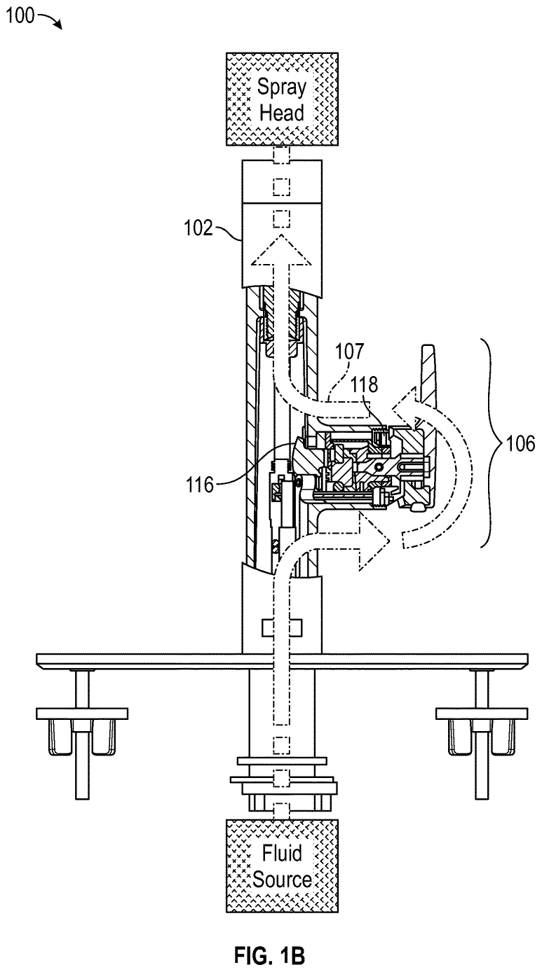

FIG. 2 shows a conceptual diagram of a faucet assembly 200 wherein an AI-based gesture recognition assembly (which includes camera sensor 208 and processors 211) controls a first valve 210, and wherein a handle 206 controls a second valve 218. First valve 210 and second valve 218 are positioned in series with one another along the same fluid flow path 207 running from a fluid source to a spray head 204, according to some embodiments.

The first valve 210 may be operated via gesture control, wherein a user's hand gestures, as detected by the camera sensor 208 and recognized by the processors 211, may cause the processors 211 to instruct the first valve 210 to move between an ON configuration and an OFF configuration. The second valve 218 may be operated via handle control, wherein a user manually turns, lifts, or manipulates the handle 206 in order to cause the second valve 218 to move between an ON configuration and an OFF configuration. In some embodiments, the faucet assembly 200 may be configured such that water starts being dispensed only when both the first valve 210 and the second valve 218 are each moved to an ON configuration. In some embodiments, water may stop being dispensed as long as either of the first valve 210 or the second valve 218 are moved to an OFF configuration. In some embodiments, the gesture-controlled first valve 210 may be fluidly connected to and positioned upstream of the handle-controlled second valve 218 along the fluid flow path 207. Alternatively, in some embodiments, the gesture-controlled first valve 210 may be fluidly connected to and positioned downstream of the handle-controlled second valve 218 along the fluid flow path 207. Both the gesture-controlled first valve 210 and the handle-controlled second valve 218 may be fluidly connected to and positioned upstream of the spray head 204, such that fluid from the fluid source must pass through both the first valve 210 and the second valve 218 in order to be dispensed by the spray head 204. In some embodiments, the faucet assembly 200 may comprise a proximity sensor.

In some embodiments, the spray head 204 includes a nozzle that is configured to dispense fluid out of the faucet assembly 200. Spray head 204 of FIG. 2 can include any features of spray head 104 of FIG. 1A, and vice versa.

In some embodiments, the handle 206 includes a handle for operating the faucet assembly 200. Handle 206 of FIG. 2 can include any features of handle 106 of FIGS. 1A and 1B, and vice versa.

In some embodiments, the fluid flow path 207 comprises a conduit that directs and carries water from the direction of a fluid source toward the direction of the spray head. The fluid flow path 207 may be fluidly connected to two valves: the first valve 210 and the second valve 218. Fluid flow path 207 of FIG. 2 can include any features of fluid flow path 107 of FIGS. 1A and 1B, and vice versa.

In some embodiments, the camera sensor 208 includes a sensor that captures or detects image data of a user of the faucet assembly 200. Camera sensor 208 of FIG. 2 can include any features of camera sensor 108 of FIG. 1A, and vice versa.

In some embodiments, the first valve 210 includes a valve movable between an ON configuration and an OFF configuration to control fluid flow along the fluid flow path 207. First valve 210 of FIG. 2 can include any features of first valve 110 of FIG. 1A, and vice versa.

In some embodiments, the processors 211 include one or more microcontrollers, PCBs, or other electronic components to control the faucet assembly 200. In particular, the processors 211 may provide AI-based gesture recognition functionality that is used to control first valve 210. In some embodiments, the processors 211 may be electronically connected to the camera sensor 208, the first valve 210, and any other wires, batteries, valves, processors, motors, or other electronic components of the faucet assembly 200. In some embodiments, the electronic connections may be wireless. In some embodiments, the processors 211 may be configured to perform AI-based gesture recognition based on image data obtained from the camera sensor 208. One or more software packages pre-loaded on the processors 211 may contain programs to identify a user's hand or hands from the image data, recognize gestures performed by the user's hand or hands, and/or instruct the first valve 210 to move between an ON configuration and an OFF configuration based on the recognized gestures. In some embodiments, one or more machine learning algorithms pre-loaded on the processors 211 may be used to recognize differences in image data of a closed fist versus image data of an open hand. The software packages and/or the machine learning algorithms may be updated or modified after the initial pre-loading onto the processors 211, thereby updating or modifying the functionality of the faucet assembly 200, and in particular, the functionality of the AI gesture recognition assembly.

In some embodiments, the faucet assembly 200 may comprise a toggle, knob, dial, switch, or other adjustable feature for manually controlling the temperature of the fluid dispensed from the faucet assembly 200. The user may preset a temperature at which fluid will be dispensed. The processors 211 may be electronically connected to this manual temperature control feature. To ensure that the temperature of the fluid dispensed from the faucet assembly 200 matches the temperature preset by the user, the processors 211 may communicate with any valves, motors, sensors, or other electronically connected components of the faucet assembly 200.

In some embodiments, the second valve 218 includes a valve movable between an ON configuration and an OFF configuration to control fluid flow along the fluid flow path 207. Second valve 218 of FIG. 2 can include any features of second valve 118 of FIG. 1B, and vice versa.

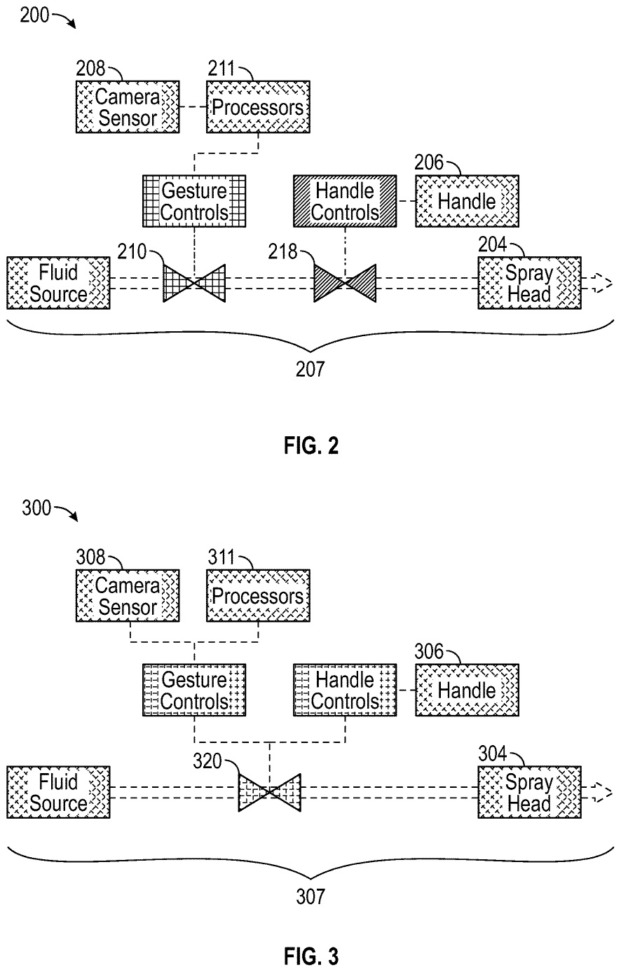

FIG. 3 shows a conceptual diagram of faucet assembly 300 wherein an AI-based gesture recognition assembly (which includes camera sensor 308 and processors 311) controls the same valve 320 as a handle 306. The valve 320 may be operated via handle control, wherein a user manually turns, lifts, or manipulates the handle 306 in order to instruct the valve 320 to move between an ON configuration and an OFF configuration. The valve 320 may also be operated via gesture control, wherein a user's hand gestures, as detected by the camera sensor 308, may instruct the valve 320 to move between an ON configuration and an OFF configuration. For example, the faucet assembly 300 may be configured such that the handle 306 may be moved to a position for dispensing water out of the faucet body by the spray head 304 at a desired water temperature and flow rate, and the gesture control instructs the valve 320 to move between an ON configuration and an OFF configuration to control whether fluid is being dispensed out of the faucet body by the spray head 304. The faucet assembly 300 may be configured such that handle control overrides gesture control, or vice versa. For example, when handle control overrides gesture control, moving the handle may override controlling the first valve based on the signal transmitted based on the recognized gesture, and when gesture control overrides handle control, transmitting the signal to the first valve based on the recognized gesture may override controlling the first valve based on moving the handle. Alternatively, the faucet assembly 300 may be configured such that water starts being dispensed only when both the handle control and the gesture control instruct, in tandem, the valve 320 to move to an ON configuration. Alternatively, the faucet assembly 300 may be configured such that water stops being dispensed only when both the handle control and the gesture control instruct, in tandem, the valve 320 to move to an OFF configuration. The valve 320 may be positioned on a fluid flow path 307 running from a fluid source to a spray head 304, according to some embodiments. Furthermore, the valve 320 may be fluidly connected to and positioned upstream of the spray head 304, such that fluid from the fluid source must pass through the valve 320 in order to be dispensed by the spray head 304. In some embodiments, the faucet assembly 300 may comprise a proximity sensor.

In some embodiments, the spray head 304 includes a nozzle that is configured to dispense fluid out of the faucet assembly 300. Spray head 304 of FIG. 3 can include any features of spray head 104 of FIG. 1A and/or spray head 204 of FIG. 2, and vice versa.

In some embodiments, the handle 306 includes a handle for operating the faucet assembly 300. Handle 306 of FIG. 3 can include any features of handle 106 of FIGS. 1A and 1B and/or handle 206 of FIG. 2, and vice versa.

In some embodiments, the fluid flow path 307 comprises a conduit that directs and carries water from the direction of a fluid source toward the direction of the spray head. The fluid flow path 307 may be fluidly connected to one valve: the valve 320. Fluid flow path 307 of FIG. 3 can include any features of fluid flow path 107 of FIGS. 1A and 1B and/or fluid flow path 207 of FIG. 2, and vice versa.

In some embodiments, the camera sensor 308 includes a sensor that captures or detects image data of a user of the faucet assembly 300. Camera sensor 308 of FIG. 3 can include any features of camera sensor 108 of FIG. 1A and/or camera sensor 208 of FIG. 2, and vice versa.

In some embodiments, the processors 311 include one or more microcontrollers, PCBs, or other electronic components to control the faucet assembly 300. In particular, the processors 311 may be associated with an AI gesture recognition assembly, which provides gesture control functionality for the valve 320. Processors 311 of FIG. 3 can include any features of processors 211 of FIG. 2, and vice versa.

In some embodiments, the valve 320 includes a valve movable between an ON configuration and an OFF configuration to control fluid flow along the fluid flow path 307. The valve 320 may be operated via gesture control, handle control, or both. In some embodiments, handle control may override gesture control. Alternatively, in some embodiments, gesture control may override handle control. Valve 320 of FIG. 3 can include any features of first valve 110 of FIG. 1A, second valve 118 of FIG. 1B, first valve 210 of FIG. 2, and/or second valve 218 of FIG. 2, and vice versa.

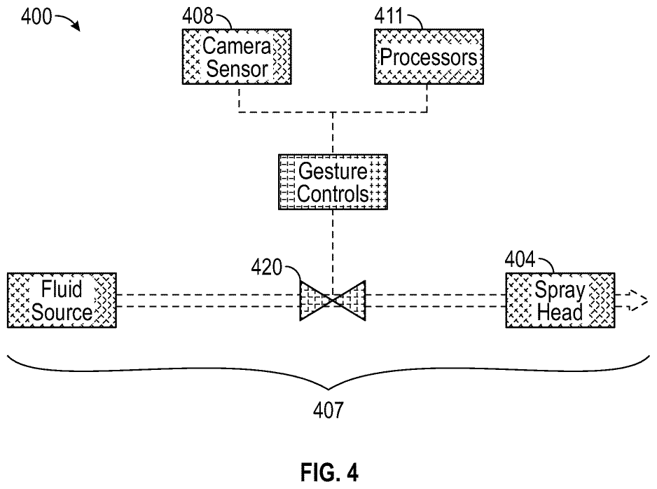

FIG. 4 shows a conceptual diagram of faucet assembly 400 wherein an AI-based gesture recognition assembly (which includes camera sensor 408 and processors 411) controls a valve 420. The valve 420 may be operated via gesture control, wherein a user's hand gestures, as detected by the camera sensor 408, may instruct the valve 420 to move between an ON configuration and an OFF configuration. The valve 420 may be positioned on a fluid flow path 407 running from a fluid source to a spray head 404, according to some embodiments. Furthermore, the valve 420 may be fluidly connected to and positioned upstream of the spray head 404, such that fluid from the fluid source must pass through the valve 420 in order to be dispensed by the spray head 404. Because handle control is not needed to operate the valve 420, the faucet assembly 400 does not necessarily comprise a handle. In some embodiments, the faucet assembly 400 may comprise a proximity sensor.

In some embodiments, the spray head 404 includes a nozzle that is configured to dispense fluid out of the faucet assembly 400. Spray head 404 of FIG. 4 can include any features of spray head 104 of FIG. 1A, spray head 204 of FIG. 2, and/or spray head 304 of FIG. 3, and vice versa.

In some embodiments, the fluid flow path 407 comprises a conduit that directs and carries water from the direction of a fluid source toward the direction of the spray head. The fluid flow path 407 may be fluidly connected to one valve: the valve 420. Fluid flow path 407 of FIG. 4 can include any features of fluid flow path 107 of FIGS. 1A and 1B, fluid flow path 207 of FIG. 2, and/or fluid flow path 307 of FIG. 3, and vice versa.

In some embodiments, the camera sensor 408 includes a sensor that captures or detects image data of a user of the faucet assembly 400. Camera sensor 408 of FIG. 4 can include any features of camera sensor 108 of FIG. 1A, camera sensor 208 of FIG. 2, and/or camera sensor 308 of FIG. 3, and vice versa.

In some embodiments, the processors 411 include one or more microcontrollers, PCBs, or other electronic components to control the faucet assembly 400. In particular, the processors 411 may be associated with an AI gesture recognition assembly, which provides gesture control functionality for the valve 420. Processors 411 of FIG. 4 can include any features of processors 211 of FIG. 2 and/or processors 311 of FIG. 3, and vice versa.

In some embodiments, the valve 420 includes a valve movable between an ON configuration and an OFF configuration to control fluid flow along the fluid flow path 407. The valve 420 may be operated via gesture control. Valve 420 of FIG. 4 can include any features of first valve 110 of FIG. 1A, second valve 118 of FIG. 1B, first valve 210 of FIG. 2, second valve 218 of FIG. 2, and/or valve 320 of FIG. 3, and vice versa.

The above embodiments describe using AI-based gesture recognition capabilities to operate faucets via gesture control; specifically, they describe using a user's hand gestures to turn the faucets ON and OFF by presenting an open hand and a closed fist, respectively, to a camera sensor. However, the gesture control capabilities described herein are not merely limited to the above embodiments. For example, the processors of any faucets described herein may be configured to recognize hand gestures beyond an open hand or a closed fist, including but not limited to: sign language, holding up a specific number of fingers, or moving a hand in a pattern. In fact, they are not limited to recognizing hand gestures and may be configured to recognize other user gestures, including but not limited to: waving an arm, miming an action, moving lips to speak a word or words, or movement about an area (e.g., walking toward or away from the faucet) in which the faucet is located. Furthermore, the gesture control capabilities may be configured to associate different gestures with different actions beyond the ON/OFF action described in the above embodiments, including but not limited to: increasing or decreasing a flow rate of fluid, dispensing a predetermined volume of fluid, raising or lowering the fluid temperature, setting a predetermined fluid temperature, changing between spray patterns, or disabling the handle control capabilities of the faucet. For example, moving a hand up and down may increase or decrease the fluid flow rate, and moving a hand left to right may raise or lower the fluid temperature. In some embodiments, these actions may be performed in conjunction with each other and/or with the ON/OFF action.

In some embodiments, upon recognizing a specific user gesture, the processors of any faucets described herein may instruct one or more valves to move from the OFF configuration to the ON configuration. The one or more valves may be configured to automatically return to an OFF configuration after a predetermined amount of time has passed, or until a predetermined amount of fluid has been dispensed, and/or until another condition is met. No gesture recognition may be necessary for the valves to return to the OFF configuration. For example, in some embodiments, upon recognizing that a user's hand or hands are open, the processors may turn the faucet ON. After a predetermined among of time, such as 30 seconds, or after a predetermined amount of fluid has been dispensed, such as 500 mL, the faucet may automatically turn OFF, with no user input or gestures required.

In some embodiments, upon recognizing a specific user gesture, such as a “thumbs up,”, processors of any faucets described herein may enter a “mapping mode.” In this mode, the user may be prompted once to display the current gesture for a function they wish to replace, and prompted again for the new desired gesture, which may be recorded and saved for use from then on. Subsequently, upon recognizing the new desired gesture, the processors may, for example, turn the faucet ON or OFF. In some embodiments, the user may use a remote controller, electronically connected to the processors, to select predefined function and remap it with a desired predefined gesture from a catalogue.

In some embodiments, the camera sensors of the faucets described herein may be configured to capture a broad range of image data, and likewise, the processors electronically connected to the camera sensor may be configured to recognize a broad range of objects or features in the image data. Thus, the AI-based recognition capabilities of the faucets described herein are not merely limited to user gestures. For example, in some embodiments, upon detecting image data of an object positioned beneath the faucet spout, and upon recognizing from the image data that the object beneath the faucet spout is a bucket, the faucet may be turned ON. Alternatively, in some embodiments, upon recognizing from the image data that the object beneath the faucet spout is a phone, the faucet will not be turned ON.

The above embodiments describe faucets with camera sensors for detecting image data of users. However, the sensors of the faucets described herein are not merely limited to camera sensors. In some embodiments, the faucets described herein may also include a proximity sensor. The proximity sensor may be replaced by or provided along with an alternative sensor, for example, but not limited to, a different type of proximity sensor, a presence sensor, a motion sensor, a voice activation sensor, an external controller, etc. Like the camera sensors described herein, the proximity sensor may be positioned on a front surface of the faucet body that faces the user during operation. In some embodiments, the proximity sensor may instruct one or more valves to move from the ON configuration to the OFF configuration and/or from the OFF configuration to the ON configuration. When the presence of a user or object near the faucet is detected by the proximity sensor, the faucet may be turned ON. In some embodiments, the presence of a user or object near the faucet must be detected by the proximity sensor in order to activate the AI-based gesture recognition capabilities of the faucet. The AI-based gesture recognition capabilities in such embodiments may go inactive when they are not in use, thereby saving energy. In some embodiments, the AI-based gesture recognition capabilities of the faucet may be activated only when the presence of a user or object near the faucet is detected by the proximity sensor. Such embodiments prevent the accidental activation of the faucet, such that gestures from across the room do not accidentally turn the faucet ON. Alternatively, in some embodiments, the AI-based gesture recognition capabilities of the faucet may be deactivated when the presence of a user or object near the faucet is detected by the proximity sensor. In such embodiments, when a user or object is near the faucet, the input from the proximity sensor may override the input from the camera sensor, and the faucet may function similarly to a conventional automatic faucet, or a conventional manual faucet operated by a handle. Only when the user is far enough away from the faucet may the AI-based gesture recognition capabilities activate.

In some embodiments, the first valve and second valve may be positioned in parallel along parallel portions of the fluid flow path. In such embodiments, water may start being dispensed as long as either of the first valve or the second valve are moved to an ON configuration. In some embodiments, the faucet assembly may be also configured such that water stops being dispensed only when both the first valve and the second valve are each moved to an OFF configuration.

### EXAMPLE EMBODIMENTS

Embodiments disclosed herein may include:
Embodiment 1. A faucet assembly comprising:
a faucet body comprising:
a fluid inlet configured to receive fluid from a fluid source;
a first valve movable between an ON configuration and an OFF configuration to control flow of the received fluid along a fluid flow path;
a spray head comprising one or more fluid outlets fluidly connected to the fluid flow path and configured to dispense fluid out of the faucet body; and
a camera sensor configured to detect image data of a user of the faucet assembly; and
one or more processors electronically connected to the camera sensor and to the valve, the one or more processors configured to:
perform AI-based gesture recognition based on the detected image data to recognize a gesture of the user, and
transmit a signal to the first valve, based on the recognized gesture, to cause the first valve to move from the ON configuration to the OFF configuration or from the OFF configuration to the ON configuration.
Embodiment 2. The faucet assembly of embodiment 1, wherein the first valve is a solenoid valve.
Embodiment 3. The faucet assembly of embodiment 1 or embodiment 2, wherein moving the first valve from the ON configuration to the OFF configuration allows the spray head of the faucet body to stop dispensing fluid.
Embodiment 4. The faucet assembly of any of embodiments 1-3, wherein moving the first valve from the OFF configuration to the ON configuration allows the spray head of the faucet body to start dispensing fluid.
Embodiment 5. The faucet assembly of any of embodiments 1-4, wherein the first valve may be configured to automatically return to an OFF configuration once a predetermined amount of time has passed, and wherein no AI-based gesture recognition is necessary for the first valve to return to the OFF configuration.
Embodiment 6. The faucet assembly of any of embodiments 1-5, wherein the first valve may be configured to automatically return to an OFF configuration once a predetermined amount of fluid has been dispensed, and wherein no AI-based gesture recognition is necessary for the first valve to return to the OFF configuration.
Embodiment 7. The faucet assembly of any of embodiments 1-6, wherein in the ON configuration, the first valve is fully open or partially open.
Embodiment 8. The faucet assembly of any of embodiments 1-7, wherein the faucet body further comprises a handle.
Embodiment 9. The faucet assembly of embodiment 8, wherein the handle is a lever handle.
Embodiment 10. The faucet assembly of embodiment 8 or embodiment 9, wherein the handle is configured to control the first valve.
Embodiment 11. The faucet assembly of any of embodiments 8-10, wherein the handle is configured to control a second valve movable between an ON configuration and an OFF configuration.
Embodiment 12. The faucet assembly of embodiment 11, wherein the second valve is a disk valve.
Embodiment 13. The faucet assembly of embodiment 11 or embodiment 12, wherein the second valve is fluidly connected to the fluid flow path and positioned upstream or downstream of the first valve.
Embodiment 14. The faucet assembly of any of embodiments 11-13, wherein the second valve is positioned in series with the first valve.
Embodiment 15. The faucet assembly of any of embodiments 8-14, configured to operate by moving the handle, to operate by transmitting the signal to the first valve based on the recognized gesture, or to operate by both.
Embodiment 16. The faucet assembly of embodiment 15, wherein the handle is moved to a position for dispensing fluid out of the faucet body by the spray head at a desired flow rate and a desired temperature, and wherein, based on the image data of the user, the first valve moves between the ON configuration and the OFF configuration to control whether fluid is being dispensed out of the faucet body by the spray head.
Embodiment 17. The faucet assembly of embodiment 15 or embodiment 16, wherein handle control overrides gesture control, such that moving the handle overrides controlling the first valve based on the signal transmitted based on the recognized gesture.
Embodiment 18. The faucet assembly of embodiment 15 or embodiment 16, wherein gesture control overrides handle control, such that transmitting the signal to the first valve based on the recognized gesture overrides controlling the first valve based on moving the handle.
Embodiment 19. The faucet assembly of any of embodiments 8-18, further comprising a proximity sensor configured to detect a user in proximity to the sensor, wherein the one or more processors transmit a signal to the first valve, based on the presence of the user or an object near the faucet assembly, to move the first valve from the ON configuration to the OFF configuration or from the OFF configuration to the ON configuration.
Embodiment 20. The faucet assembly of embodiment 19, wherein the AI-based gesture recognition capabilities of the one or more processors are inactive until the presence of the user or the object near the faucet assembly is detected by the proximity sensor.
Embodiment 21. The faucet assembly of embodiment 19, wherein the AI-based gesture recognition capabilities of the one or more processors are deactivated when the presence of the user or the object near the faucet assembly is detected by the proximity sensor.
Embodiment 22. The faucet assembly of any of embodiments 1-21, wherein the faucet body is a kitchen faucet.
Embodiment 23. The faucet assembly of any of embodiments 1-22, wherein the faucet body further comprises an outer housing comprising:
a spout configured to hold the fluid flow path of the faucet body; and
an escutcheon plate configured to be mounted on a top surface of a sink deck;
wherein one end of the spout is configured to connect to the spray head of the faucet body and another end of the spout is configured to connect to the escutcheon plate.
Embodiment 24. The faucet assembly of embodiment 23, wherein the camera sensor is fixed to a sensor holder mounted within the spout and positioned proximate to an opening in the front of the spout.
Embodiment 25. The faucet assembly of any of embodiments 1-24, wherein the AI-based gesture recognition capabilities of the one or more processors are configured to associate different gestures with different actions, including but not limited to: raising or lowering a fluid temperature, changing between a plurality of spray patterns, or disabling one or more capabilities of the faucet.
Embodiment 26. The faucet assembly of any of embodiments 1-25, wherein the gesture of a user is an open hand or a closed fist.
Embodiment 27. The faucet assembly of embodiment 26, wherein upon recognizing the gesture of the user as an open hand, the one or more processors transmit a signal to the first valve to cause the first valve to move from the OFF configuration to the ON configuration.
Embodiment 28. The faucet assembly of embodiment 26 or embodiment 27, wherein upon recognizing the gesture of the user as a closed fist, the one or more processors transmit a signal to the first valve to cause the first valve to move from the ON configuration to the OFF configuration.
Embodiment 29. The faucet assembly of any of embodiments 1-28, further comprising a battery electronically connected to the camera sensor and to the one or more processors.
Embodiment 30. The faucet assembly of any of embodiments 1-29, wherein the one or more processors include a PCB.
Embodiment 31. The faucet assembly of any of embodiments 1-30, wherein the faucet body further comprises a toggle switch configured to disable and enable the camera sensor detecting the image data of the user.
Embodiment 32. The faucet assembly of any of embodiments 1-31, wherein the one or more processors are electronically connected to a manual temperature control, and wherein a temperature of the fluid is determined according to a setting of the manual temperature control.
Embodiment 33. The faucet assembly of embodiment 32, wherein the manual temperature control comprises a knob or dial.

The foregoing description, for the purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

Although the disclosure and examples have been fully described with reference to the accompanying figures, it is to be noted that various changes and modifications will become apparent to those skilled in the art. Such changes and modifications are to be understood as being included within the scope of the disclosure and examples as defined by the claims. Finally, the entire disclosure of the patents and publications referred to in this application are hereby incorporated herein by reference.

1. A faucet assembly comprising:
a faucet body comprising:
a fluid inlet configured to receive fluid from a fluid source;
a first valve movable between an ON configuration and an OFF configuration to control flow of the received fluid along a fluid flow path;
a spray head comprising one or more fluid outlets fluidly connected to the fluid flow path and configured to dispense fluid out of the faucet body; and
a camera sensor configured to detect image data of a user of the faucet assembly; and
one or more processors electronically connected to the camera sensor and to the valve, the one or more processors configured to:
perform AI-based gesture recognition based on the detected image data to recognize a gesture of the user; and
transmit a signal to the first valve, based on the recognized gesture, to cause the first valve to move from the ON configuration to the OFF configuration or from the OFF configuration to the ON configuration.

2. The faucet assembly of claim 1, wherein moving the first valve from the ON configuration to the OFF configuration allows the spray head of the faucet body to stop dispensing fluid, and wherein moving the first valve from the OFF configuration to the ON configuration allows the spray head of the faucet body to start dispensing fluid.

3. The faucet assembly of claim wherein the first valve may be configured to automatically return to an OFF configuration once one or both of:
a predetermined amount of time has passed, and
a predetermined amount of fluid has been dispensed, and
wherein no AI-based gesture recognition is necessary for the first valve to return to the OFF configuration.

4. The faucet assembly of claim 1, wherein in the ON configuration, the first valve is fully open or partially open.

5. The faucet assembly of claim 1, wherein the faucet body further comprises a handle.

6. The faucet assembly of claim 5, wherein the handle is configured to control the first valve.

7. The faucet assembly of claim 5, wherein the handle is configured to control a second valve movable between an ON configuration and an OFF configuration.

8. The faucet assembly of claim 7, wherein the second valve is fluidly connected to the fluid flow path and positioned in series with the first valve upstream or downstream of the first valve.

9. The faucet assembly of claim 5, wherein the faucet assembly is configured to operate by one or both of:
moving the handle, and
transmitting the signal to the first valve based on the recognized gesture.

10. The faucet assembly of claim 5, wherein the handle is moved to a position for dispensing fluid out of the faucet body by the spray head at a desired flow rate and a desired temperature, and wherein, based on the detected image data of the user, the first valve moves between the ON configuration and the OFF configuration to control whether fluid is being dispensed out of the faucet body by the spray head.

11. The faucet assembly of claim 5, wherein handle control overrides gesture control, such that moving the handle overrides controlling the first valve based on the signal transmitted based on the recognized gesture.

12. The faucet assembly of claim 5, wherein gesture control overrides handle control, such that transmitting the signal to the first valve based on the recognized gesture overrides controlling the first valve based on moving the handle.

13. The faucet assembly of claim 5, further comprising a proximity sensor configured to detect a user in proximity to the sensor, wherein the one or more processors transmit a signal to the first valve, based on the presence of the user or an object near the faucet assembly, to move the first valve from the ON configuration to the OFF configuration or from the OFF configuration to the ON configuration.

14. The faucet assembly of claim 13, wherein the AI-based gesture recognition capabilities of the one or more processors are inactive until the presence of the user or the object near the faucet assembly is detected by the proximity sensor.

15. The faucet assembly of claim 13, wherein the AI-based gesture recognition capabilities of the one or more processors are deactivated when the presence of the user or the object near the faucet assembly is detected by the proximity sensor.

16. The faucet assembly of claim 1, wherein the faucet body further comprises:
an outer housing comprising:
a spout configured to hold the fluid flow path of the faucet body; and
an escutcheon plate configured to be mounted on a top surface of a sink deck,
wherein one end of the spout is configured to connect to the spray head of the faucet body and another end of the spout is configured to connect to the escutcheon plate, and
wherein the camera sensor is fixed to a sensor holder mounted within the spout and positioned proximate to an opening in the front of the spout.

17. The faucet assembly of claim 1, wherein the AI-based gesture recognition capabilities of the one or more processors are configured to associate different gestures with different actions, including but not limited to: raising or lowering a fluid temperature, changing between a plurality of spray patterns, or disabling one or more capabilities of the faucet.

18. The faucet assembly of claim 1, wherein upon recognizing the gesture of the user as an open hand, the one or more processors transmit a signal to the first valve to cause the first valve to move from the OFF configuration to the ON configuration, and wherein upon recognizing the gesture of the user as a closed fist, the one or more processors transmit a signal to the first valve to cause the first valve to move from the ON configuration to the OFF configuration.

19. The faucet assembly of claim 1, wherein the faucet body further comprises a toggle switch configured to disable and enable the camera sensor detecting the image data of the user.

20. The faucet assembly of claim 1, wherein the one or more processors are electronically connected to a manual temperature control comprising a knob or dial, and wherein a temperature of the fluid is determined according to a setting of the manual temperature control.
